(19) United States
(12) Patent Application Publication
(10) Pub. No.: US 2024/0343023 A1
(43) Pub. Date: Oct. 17, 2024

(54) LAMINATED GLASS AND METHOD FOR PRODUCING LAMINATED GLASS

(71) Applicant: AGC Inc., Tokyo (JP)

(72) Inventors: Hideo TSUBOI, Tokyo (JP); Shunsuke SADAKANE, Tokyo (JP)

(73) Assignee: AGC Inc., Tokyo (JP)

(21) Appl. No.: 18/755,545

(22) Filed: Jun. 26, 2024

Related U.S. Application Data
(63) Continuation of application No. PCT/JP2022/047288, filed on Dec. 22, 2022.

(30) Foreign Application Priority Data
Dec. 28, 2021 (JP) 2021-214752

(51) Int. Cl. B32B 17/10; B32B 3/26

(52) U.S. Cl. CPC B32B 17/10761; B32B 3/266; B32B 17/10036; B32B 17/10165; B32B 17/10935; B32B 2605/00

(57) ABSTRACT

To provide a laminated glass having plate misalignment between glass plates suppressed.

A laminated glass comprising a first glass plate, an adhesive interlayer and a second glass plate in this order,
wherein the adhesive interlayer comprises two or more adhesive layers and is partitioned into a uniform region and a nonuniform region,
the uniform region is a region positioned outside the nonuniform region in a plan view, containing only a portion in which the adhesive surface of any two adjacent adhesive layers is substantially in parallel with at least one of the first glass plate and the second glass plate, and
the nonuniform region is a region including a portion in which the adhesive surface is not in parallel with at least one of the first glass plate and the second glass plate.

This application is a continuation of PCT Application No. PCT/JP2022/047288, filed on Dec. 22, 2022, which is based upon and claims the benefit of priority from Japanese Patent Application No. 2021-214752 filed on Dec. 28, 2021 The contents of those applications are incorporated herein by reference in their entireties.

### TECHNICAL FIELD

The present invention relates to a laminated glass and a method for producing the laminated glass.

### BACKGROUND ART

A laminated glass having an adhesive interlayer such as a resin sandwiched between a plurality of glass plates, from which glass fragments will not scatter when broken, is excellent in safety and is thereby used widely for a window of a vehicle such as an automobile, a window of a building, etc.

A laminated glass production process usually includes a step of laminating a resin sheet between a plurality of glass plates to prepare an assembly, a step of conveying the assembly, a step of pressure-bonding the assembly with heating, etc. In these steps, a problem recognized as failure such that the relative position of the plurality of glass plates deviates from the predetermined position, that is so-called “plate misalignment”, may occur.

Patent Document 1 discloses a method for producing a laminated glass in which two glass plates and one hot melt adhesive film (as a resin sheet) are laminated, the glass plates are partly heated by an electric heater to melt the hot melt adhesive film positioned near the partly heated glass plates thereby to partly bond the glass plates and the hot melt adhesive film. Patent Document 1 discloses that by the above method, plate misalignment of the glass plates can be prevented from after the glass plates and the adhesive film are laminated until the preliminary bonding is completed.

In recent years, to a laminated glass, in addition to safety such as prevention of scattering, various functions are to be imparted by properly selecting a resin sheet constituting the adhesive interlayer. For example, by using a resin sheet having a plurality of resin layers differing in the properties laminated, sound insulation performance of a laminated glass can be improved. As such a laminated glass, one having an adhesive interlayer including two or more (in many cases three) resin layers differing in the glass transition point may be mentioned.

However, if the resin sheets slip during the production process, a laminated glass having a plurality of resin sheets laminated may have plate misalignment after all. Particularly, Patent Document 1 does not disclose bonding of a plurality of resin sheets, and plate misalignment of the laminated glass may not sufficiently be prevented.

### PRIOR ART DOCUMENTS

### patent documents

Patent Document 1: Japanese Patent No. 4821726

### DISCLOSURE OF INVENTION

### Technical Problem

Under these circumstances, the object of the present invention is to provide a laminated glass of which plate misalignment of glass plates is suppressed.

### Solution to Problem

According to an aspect of the disclosure, provided is a laminated glass [1] comprising a first glass plate, an adhesive interlayer and a second glass plate in this order,
wherein the adhesive interlayer comprises two or more adhesive layers and is partitioned into a uniform region and a nonuniform region,
the uniform region is a region positioned outside the nonuniform region in a plan view, containing only a portion in which the adhesive surface of any two adjacent adhesive layers is substantially in parallel with the first glass plate, and
the nonuniform region is a region including a portion in which the adhesive surface is not in parallel with the first glass plate.

According to an aspect of the disclosure, provided is a laminated glass [2] according to [1], wherein the nonuniform region is positioned at a peripheral portion of the first glass plate in a plan view.

According to an aspect of the disclosure, provided is a laminated glass [3] according to [1] or [2], wherein the adhesive interlayer comprises four or more adhesive layers.

According to an aspect of the disclosure, provided is a laminated glass [4] according to any one of [1] to [3], wherein the number of the adhesive layers of the adhesive interlayer is smaller in the nonuniform region than in the uniform region.

According to an aspect of the disclosure, provided is a laminated glass [5] according to any one of [1] to [4], wherein the two or more adhesive layers include a layer A having a glass transition point of 15° C. or higher and a layer B having a glass transition point of less than 15° C.

According to an aspect of the disclosure, provided is a laminated glass [6] according to [5], wherein in the adhesive interlayer, the layer A and the layer B are alternately laminated, and two or more layers B are included.

According to an aspect of the disclosure, provided is a laminated glass [7] according to any one of [1] to [6], wherein the adhesive interlayer has a functional member in its interior.

According to an aspect of the disclosure, provided is a laminated glass [8] according to [7], wherein the functional member is provided outside the nonuniform region.

According to an aspect of the disclosure, provided is a laminated glass [9] according to [7] or [8], wherein the functional member is a layered member having at least one function of changing a visible light transmittance or haze, light emission, heat generation, infrared shielding, ultraviolet shielding, forming an image projected from an external light source, and reflection of p-polarized light.

According to an aspect of the disclosure, provided is a laminated glass [10] according to any one of [1] to [9], wherein the nonuniform region has a width of 20 mm or less in a plan view.

According to an aspect of the disclosure, provided is a laminated glass [11] according to any one of [1] to [10], which has a shielding portion on the peripheral region of at least one of the first glass plate and the second glass plate, and the nonuniform region overlaps the shielding portion in a plan view.

According to an aspect of the disclosure, provided is a laminated glass [12] according to any one of [1] to [11], wherein the loss factor at the primary resonance point measured at a temperature of 20° C. in a frequency region of 0 Hz to 10,000 Hz is 0.1 or more.

According to an aspect of the disclosure, provided is a method [13] for producing the laminated glass as defined in any one of [1] to [12], comprising
step (a) of laminating two or more resin sheets,
step (b) of temporarily bonding the two or more resin sheets laminated to prepare a composite resin sheet,
step (c) of laminating the first glass plate, the composite resin sheet and the second glass plate in this order to prepare an assembly, and
step (d) of heating and pressurizing the assembly to bond the first glass plate and the second glass plate.

According to an aspect of the disclosure, provided is a method [14] for producing the laminated glass according to [13], wherein step (b) includes step (b-1) of heating a predetermined position of the two or more resin sheets laminated and step (b-2) of forming a hole at the predetermined position.

According to an aspect of the disclosure, provided is a method [15] for producing the laminated glass according to [14], wherein step (b-1) is conducted prior to step (b-2), or step (b-1) and step (b-2) are conducted simultaneously.

### Advantageous Effects of Invention

According to an aspect of the disclosure, provided are a laminated glass of which plate misalignment of glass plates is suppressed, and a method for producing the laminated glass.

### BRIEF DESCRIPTION OF DRAWINGS

FIG. 1 is a plan view illustrating a laminated glass according to a first embodiment.

FIG. 2A is a cross sectional view illustrating a laminated glass according to the first embodiment. FIG. 2B is an enlarged view illustrating the vicinity of the nonuniform region shown in FIG. 2A.

FIG. 3 is a cross sectional view illustrating a laminated glass according to a first modified example of the first embodiment.

FIG. 4 is a cross sectional view illustrating a laminated glass according to a second modified example of the first embodiment.

FIG. 5 is a cross sectional view illustrating a laminated glass according to a third modified example of the first embodiment.

FIG. 6 is a plan view illustrating a laminated glass according to a second embodiment.

FIG. 7 is a cross sectional view illustrating the laminated glass according to the second embodiment.

FIG. 8 is a plan view illustrating a laminated glass according to a third embodiment.

FIG. 9 is a cross sectional view illustrating the laminated glass according to the third embodiment.

FIGS. 10A to 10D are views illustrating a method for producing the laminated glass of the present invention.

### DESCRIPTION OF EMBODIMENTS

In this specification, the “cross section” means a cut surface of the laminated glass cut in a thickness direction. Further, a “periphery” means an outermost edge of a predetermined member, and the “peripheral portion” means a vicinity of the “periphery”. The “same shape” means having the same shape and the same dimensions as viewed by a human. And, unless otherwise specified, “substantially” means being the same as viewed by a human. “to” representing a range of numerals include upper and lower limits.

The laminated glass of the present invention is applicable to, for example, a window glass, a showcase and a transparent partition of a building, a portion to which external light enters such as a vehicle window (for example a windshield, a side window, a quarter window, a roof, a rear window and an extra window disposed behind a rear window).

Now, an example in which the laminated glass of the present invention is used as a side window of a vehicle, will be described below, but the present invention is not limited to such an example. A vehicle is used to refer to any mobile vehicle that can be equipped with the laminated glass, including a train, a ship, an aircraft, etc., although the most common vehicle is an automobile. The embodiment in the drawings is schematically illustrated to clearly describe the present invention and does not necessarily illustrate accurate size or scale of an actual product.

### First Embodiment

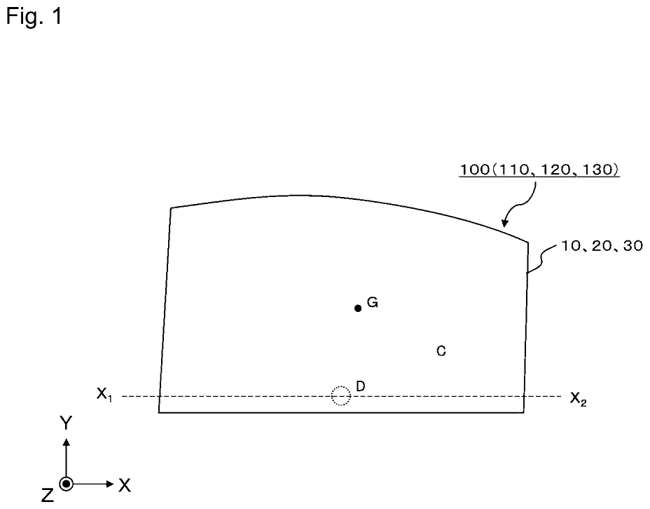

Now, a first embodiment will be described with reference to FIGS. 1 to 5. FIG. 1 is a plan view illustrating the laminated glass according to the first embodiment of the present invention. FIG. 1 is also a plan view illustrating first to third modified examples of the first embodiment described later.

FIG. 1 is a plan view illustrating a laminated glass 100 according to an embodiment of the present invention. In FIG. 1, in attachment of the laminated glass 100 to a vehicle, the vehicle front-back direction is taken as X-axis direction, the vehicle up-and-down direction as Y-axis direction, and a direction perpendicular to XY plane as Z-axis direction (the same applies to other drawings). However, in a case where the laminated glass 100 is used for a windshield for example, within a range not to impair the effects of the invention, the directions may be interpreted in another way such that the right-left direction of a vehicle on which the laminated glass 100 is to be mounted is X-axis direction, the vehicle up-and-down direction is Y-axis direction and the direction perpendicular to XY plane is Z-axis direction.

In the present disclosure, the center axis (not shown) of the laminated glass 100 is a virtual line in a thickness direction passing the center of gravity G of the laminated glass 100. “Inside” represents the center axis direction passing the center of gravity G of the laminated glass 100 as viewed from the periphery of a predetermined member (for example the first glass plate 10). On the other hand, “outside” means the peripheral direction of a predetermined member (for example the first glass plate 10) as viewed from the center axis passing the center of gravity G of the laminated glass 100.

The laminated glass 100 according to the present embodiment has a first glass plate 10, a second glass plate 20 and an adhesive interlayer 30 interposed therebetween. The first glass plate 10 and the second glass plate 20 have main surfaces having substantially the same shape. And, the first glass plate 10, the adhesive interlayer 30 and the second glass plate 20 are laminated in this order. In FIG. 1, the laminated glass 100 is planar, but may be curved only in X-axis direction, may be curved only in Y-axis direction or may be curved in both directions. In a case where the laminated glass is curved, the convex surface of the first glass plate 10 and the concave surface of the second glass plate 20 may face each other, and the opposite is also possible. That is, the concave surface of one glass plate faces the convex surface of the other glass plate.

As shown in FIG. 1, the laminated glass 100 is substantially trapezoidal in a plan view but is not limited thereto. The laminated glass 100 may be substantially triangular or substantially rectangular depending upon an object or position on which the laminated glass 10 is mounted. “Substantially” hear represents that whether the line is straight or curved, whether edges are in parallel with each other or not, and the angle of an apex, are not distinctly determined. However, “substantially in parallel” means the angle of a plane to another plane is 0° or more and 10° or less, and if the angle exceeds 10°, the two planes forming such an angle are not parallel. In a narrow sense, planes forming an angle exceeding 10° and up to 90° may be considered to be not in parallel. “In a plan view” means to view a predetermined region of the laminated glass 100 from a direction normal to a surface of the first glass plate 10 opposite from the second glass plate 20 (the positive direction of Z axis direction). Further, “in a cross sectional view” means to view a predetermined region from a direction perpendicular to a predetermined cross section of the laminated glass.

At least a part of the cross section of the laminated glass 100 in up-and-down direction (Y-axis direction) may be in a substantial wedge shape such that the thickness gradually decreases. A laminated glass of which at least part of the cross sectional shape in up-and-down direction is in a wedge shape such that the thickness increases from below to above, suitably functions as a head-up display (HUD) and is particularly suitable for a windshield. In order that the laminated glass 100 has such a cross sectional shape, at least one of the first glass plate 10, the second glass plate 20 and the adhesive interlayer 30 has a cross sectional shape of which at least a part in up-and-down direction is in a wedge shape.

The adhesive interlayer 30 is a layer to bond the first glass plate 10 and the second glass plate 20 and has various functions such as shock absorption and sound insulation property. Sound insulation property can be dramatically improved by using an adhesive layer having specific property or structure, which will be described later. As the adhesive interlayer 30, a material commonly used for a laminated glass may be used, including a thermoplastic resin. The adhesive interlayer 30 preferably has substantially the same shape as at least one of the first glass plate 10 and the second glass plate 20 in a plan view.

In the laminated glass of the present disclosure, the adhesive interlayer 30 has at least two adhesive layers. In the laminated glass 100 according to the present embodiment, the adhesive interlayer 30 has two adhesive layers. The number of adhesive layers which the adhesive interlayer 30 has may be 3, 4, 5, 6, 7, 8, 9 or 10. An example of a structure having three or more adhesive layers will be described later.

The adhesive interlayer 30 is partitioned into a uniform region C and a nonuniform region D. The adhesive interlayer 30 may further have another region in addition to the uniform region C and the nonuniform region D, which will be described in detail later. The uniform region C is a region including only a portion in which the adhesive surface of any two adjacent layers is substantially in parallel with the first glass plate 10. The uniform region C may be a region including only a portion in which the adhesive surface of any two adjacent layers is also substantially in parallel with the second glass plate 20. The nonuniform region D is a region including a portion in which the adhesive surface of any two adjacent layers is not in parallel with the first glass plate 10. The nonuniform region D may be a region including a portion in which the adhesive surface of any two adjacent layers is also not in parallel with the second glass plate 20.

In the laminated glass 100, the nonuniform region D is positioned inside the periphery of the adhesive interlayer 30 and is substantially circular in a plan view. In the example shown in FIG. 1, the nonuniform region D is positioned at the bottom center of the laminated glass 100, but is not limited thereto. The nonuniform region D may be provided for example at a center portion of any side of the laminated glass 100 or may be provided at an edge portion.

The nonuniform region D may overlap the periphery of the adhesive interlayer 30 but in view of excellence in adhesion between the glass plates and in appearance of the periphery of the adhesive interlayer 30, it is provided preferably inside the periphery of the adhesive interlayer 30. On the other hand, in order not to be recognized as a distortion, the nonuniform region D is provided preferably within a predetermined width from the periphery of the laminated glass 100. The predetermined width may, for example, be 500 mm, 300 mm, 250 mm, 150 mm, 100 mm, 50 mm or 30 mm. In a case where the laminated glass 100 has a shielding portion, the predetermined region may be the width of the shielding portion.

The shape of the nonuniform region D in a plan view is not limited to substantially circular and may be any optional shape (for example substantially rectangular or substantially star-shaped) but is preferably substantially circular. The number of the nonuniform region D is not limited to one and may be two or more.

Although a plate misalignment suppressing effect is obtained so long as there is one nonuniform region D, the number of the nonuniform region D is preferably 2 or more, whereby the plate misalignment suppressing effect improves. The plate misalignment in the present disclosure means misalignment between an outer peripheral side surface of the first glass plate 10 and an outer peripheral side surface of the second glass plate 20 in a plan view. The number of the nonuniform region D is not particularly limited but is preferably 10 or less to prevent a decrease of adhesion between the first glass plate 10 and the second glass plate 20 and to prevent air bubbles from remaining in the laminated glass 100. The number and the dimensions of the nonuniform region D may be determined by comprehensively considering the dimensions of the laminated glass 100, the number and the type of adhesive layers in the adhesive interlayer 30, whether a functional member described later is disposed or not, the upper limit of the plate misalignment amount, etc.

The uniform region C is positioned outside the nonuniform region D. Specifically, the entire periphery of the nonuniform region D is surrounded by the uniform region C. Further, in the laminated glass 100, the region other than the uniform region C is the nonuniform region D. In a plan view, the area of the uniform region C is preferably larger than the nonuniform region D. The shape of the uniform region C in a plan view may be any optional shape depending upon the shape of the nonuniform region D.

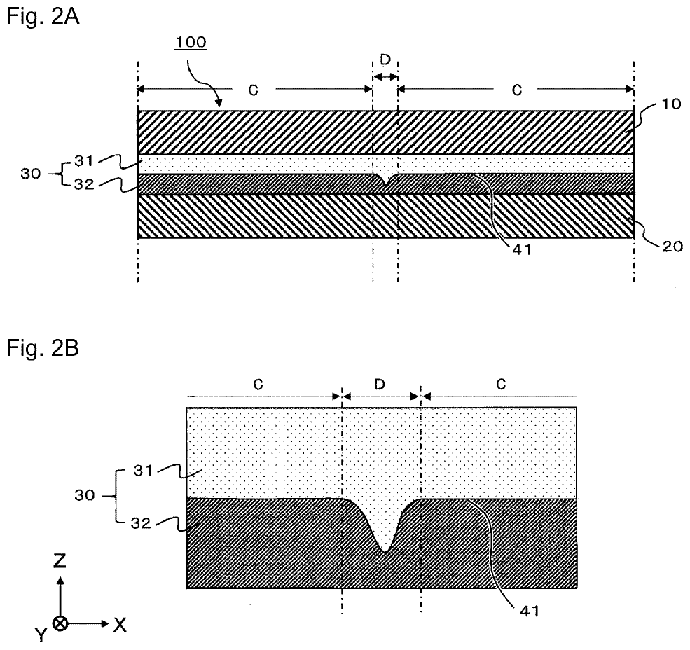

FIG. 2 is a crosse sectional view of the laminated glass 100 in FIG. 1 cut in XZ plane at the position X₁-X₂ in FIG. 1, as viewed from Y-axis direction (hereinafter sometimes referred to as “X1-X2 cross section”). FIG. 2A is an entire X1-X2 cross section of the laminated glass 100. FIG. 2B is an enlarged view illustrating the vicinity of the nonuniform region D in the X1-X2 cross section of the laminated glass 100. In FIG. 2B, the first glass plate 10 and the second glass plate 20 are omitted.

As shown in FIG. 2A, in the laminated glass 100 according to the present embodiment, the adhesive interlayer 30 has a first adhesive layer 31 and a second adhesive layer 32. That is, the laminated glass 100 is a laminate having the first glass plate 10, the first adhesive layer 31, the second adhesive layer 32 and the second glass plate 20 in this order. The first adhesive layer 31 and the second adhesive layer 32 are adjacent (bonded) to each other. The adhesive interlayer 30 has a first adhesive surface 41 which is an adhesive surface between the first adhesive layer 31 and the second adhesive layer 32.

In the uniform region C, the first adhesive surface 41 is substantially in parallel with the first glass plate 10 and the second glass plate 20. Whereas in the nonuniform region D, the first adhesive surface 41 is not in parallel (that is it forms an angle exceeding 10°) with the first glass plate 10 and the second glass plate 20. In a case where the tip of a convex, as in the case of substantial A-shape or substantial V-shape described later, is substantially in parallel with the first glass plate 10, in the nonuniform region D, the first adhesive surface 41 may be partly substantially in parallel with the first glass plate 10. The same applies to the second glass plate 20.

The first adhesive layer 31 and the second adhesive layer 32 may be layers formed of the same material or may be layers formed of different materials. The layers formed of different materials may be layers differing in the constituents or may be layers differing in the proportion of the constituents. In the example shown in FIG. 2B, in the nonuniform region D, the angles of the first adhesive surface 41 to the first glass plate 10 and the second glass plate 20 are continuous. And, in the nonuniform region D, the first adhesive surface 41 is in a substantial V-shape such that it is convex toward the second glass plate 20. However, the shape of the adhesive surface in a cross section is not limited thereto. The first adhesive surface 41 in the nonuniform region D may be in a substantial A-shape such that it is convex toward the first glass plate 10. Further, the number of convexes may be two or more. That is, in the nonuniform region D, the shape of the first adhesive surface 41 may be substantial N-shape, substantial W-shape, substantial M-shape, or the like.

The first adhesive surface 41 in the nonuniform region D may have a shape such that when mounted in a vehicle, it is convex toward the glass plate located on the vehicle exterior side. By such a shape, flying stone resistance and security are likely to be secured.

The width of the nonuniform region D is preferably 0.1 mm or more in a plan view, whereby adhesion between the adhesive layers can be increased, and is more preferably 0.2 mm or more, further preferably 0.4 mm or more, further more preferably 0.6 mm or more, particularly preferably 0.8 mm or more, and still more preferably 1 mm or more. The width of the nonuniform region D is preferably 20 mm or less in a plan view, whereby degassing failure is less likely to occur and the area of the distortion tends to be small, and is more preferably 15 mm or less, further preferably 10 mm or less, further more preferably 8 mm or less, particularly preferably 6 mm or less, still more preferably 4 mm or less.

The range of the width of the nonuniform region D may be a proper combination of such upper limit values and lower limit values, and among them, preferably 0.1 mm to 20 mm, more preferably 0.2 mm to 15 mm, further preferably 0.4 mm to 10 mm.

The width of the nonuniform region D is an arithmetic mean of the maximum distance and the minimum distance between edges of the nonuniform region D in a plan view. In the present embodiment, since the nonuniform region D is substantially circular in a plan view, the width may be read the diameter. For example, in a case where the nonuniform region D is substantially rectangular, the width of the nonuniform region D is an arithmetic mean of the length of a diagonal and the length of a short side.

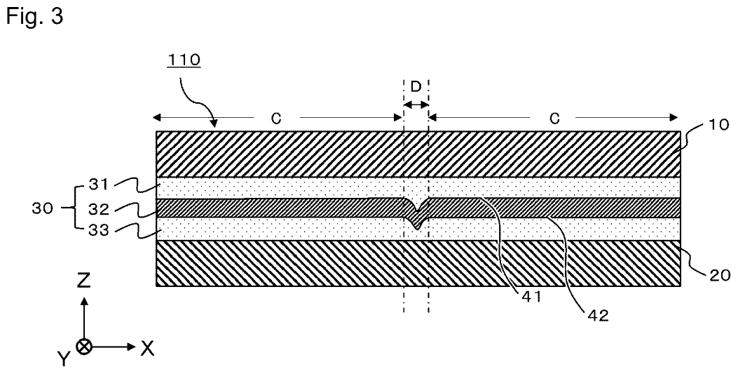

FIG. 3 is an X1-X2 cross section illustrating a laminated glass 110 according to a first modified example of the first embodiment. In the present modified example, points different from the laminated glass 100 according to the first embodiment will be described, and regarding the other points, the descriptions of the first embodiment are incorporated. The laminated glass 110 is different from the laminated glass 100 in that the adhesive interlayer 30 has a third adhesive layer 33 in addition to the first adhesive layer 31 and the second adhesive layer 32. The third adhesive layer 33 may be a layer formed of the same material as the first adhesive layer 31 or the second adhesive layer 32 or may be a layer formed of a different material.

As shown in FIG. 3, the adhesive interlayer 30 has the first adhesive layer 31, the second adhesive layer 32, the third adhesive layer 33 in this order from the first glass plate 10 side, and they are bonded to one another. For example, the second adhesive layer 32 bonds the first adhesive layer 31 and the third adhesive layer 33, and the third adhesive layer 33 bonds the second adhesive layer 32 and the second glass plate 20. And, the adhesive interlayer 30 has a second adhesive surface 42 as an adhesive surface between the second adhesive layer 32 and the third adhesive layer 33.

As shown in FIG. 3, in the uniform region C, the second adhesive surface 42 is substantially in parallel with the first glass plate 10 and the second glass plate 20. Whereas in the nonuniform region D, the second adhesive surface 42 is not in parallel (that is it forms an angle exceeding 10°) with the first glass plate 10 and the second glass plate 20. In the example shown in FIG. 3, in the nonuniform region D, the cross sectional shape of the second adhesive surface 42 is substantially V-shape, but is not limited thereto, and may be any shape exemplified for the first adhesive surface 41 in the laminated glass 100. Further, in the nonuniform region D, the cross sectional shape of the second adhesive surface 42 may be different from the shape of the first adhesive surface 41.

Usually, misalignment between adhesive layers is accumulated and increases as the number of the adhesive layers increases. Thus, the larger the number of the adhesive layers, the more plate misalignment is likely to occur, but in the present laminated glass 110, plate misalignment is effectively suppressed.

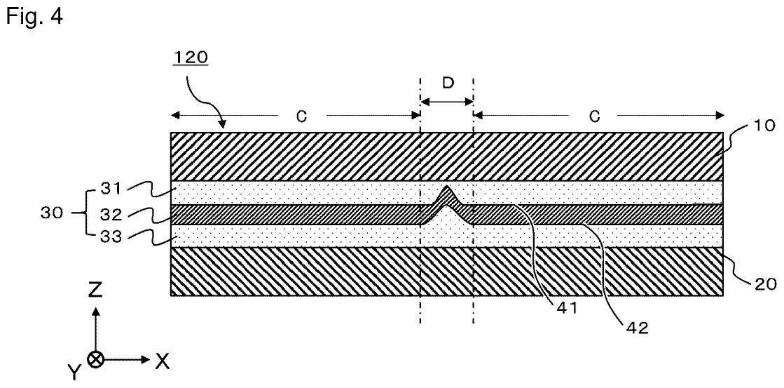

FIG. 4 is an X1-X2 cross section illustrating a laminated glass 120 according to a second modified example of the first embodiment. In the present modified example, points different from the laminated glass 110 according to the first modified example of the first embodiment will be described, and regarding the other points, the descriptions in the first modified example of the first embodiment are incorporated. In the laminated glass 120, the second adhesive layer 32 is formed of a material different from those of the first adhesive layer 31 and the third adhesive layer 33. In the vicinity of the nonuniform region D, the shape of the first adhesive surface 41 and the shape of the second adhesive surface 42 are respectively different.

In the example shown in FIG. 4, in the nonuniform region D, the shape of the first adhesive surface 41 and the shape of the second adhesive surface 42 are both substantially A-shape such that they are convex toward the first glass plate 10 side.

In the nonuniform region D, the first adhesive layer 31 and the third adhesive layer 33 are separated by the second adhesive layer 32 and are not in contact with each other. However, in the nonuniform region D, the first adhesive layer 31 and the third adhesive layer 33 may be partly in contact with each other. In such a case, the second adhesive layer 32 is partly discontinuous in the nonuniform region D. The width of a portion where the first adhesive layer 31 and the third adhesive layer 33 are in contact with each other (the width of the discontinuous portion) is preferably less than 20 mm. In the same manner as in the first modified example of the first embodiment, the cross sectional shapes of the first adhesive surface 41 and the second adhesive surface 42 may be substantially V-shape such that they are convex toward the second glass plate 20, and the shape of the first adhesive surface 41 and the shape of the second adhesive surface 42 may be different from each other.

In the example shown in FIG. 4, the width of a portion not in parallel with the first glass plate 10 is larger and the width of a portion substantially in parallel is smaller, in the second adhesive surface 42 than in the first adhesive surface 41. That is, the nonuniform region based on the first adhesive surface 41 and the nonuniform region based on the second adhesive surface 42 are different from each other. In a case where there are a plurality of adhesive surfaces of any two adjacent layers in the thickness direction as in the above case, among the nonuniform regions, the nonuniform region with the largest width may be regarded as the nonuniform region D. In the example shown in FIG. 4, the nonuniform region D may be determined based on the second adhesive surface 42. In such a case, in the nonuniform region D, the first adhesive surface 41 is partly substantially in parallel with the first glass plate 10.

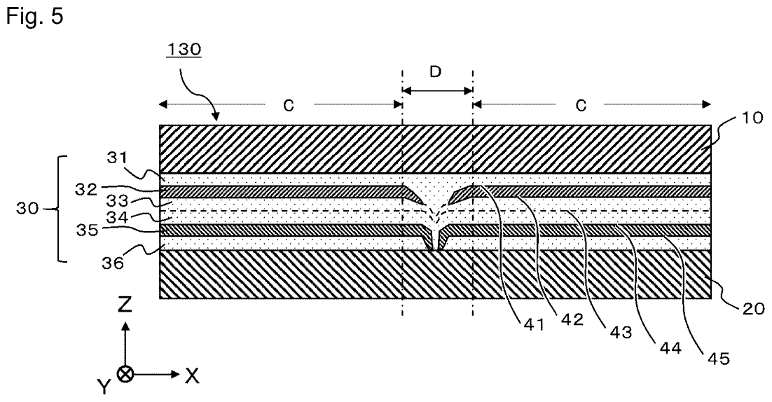

FIG. 5 is an X1-X2 cross section illustrating a laminated glass 130 according to a third modified example of the first embodiment. In the present modified example, points different from the laminated glass 100 according to the first embodiment will be described, and regarding the other points, the descriptions in the first embodiment are incorporated. The laminated glass 130 is different from the laminated glass 100 in that the adhesive interlayer 30 has a third adhesive layer 33, a fourth adhesive layer 34, a fifth adhesive layer 35 and a sixth adhesive layer 36 in addition to the first adhesive layer 31 and the second adhesive layer 32. The third adhesive layer 33 to the sixth adhesive layers 36 may be layers formed of the same material as the first adhesive layer 31 or the second adhesive layer 32 or may be layers formed of a different material.

In the adhesive interlayer 30, the uniform region C has the first adhesive layer 31, the second adhesive layer 32, the third adhesive layer 33, the fourth adhesive layer 34, the fifth adhesive layer 35 and the sixth adhesive layer 36 in this order, and these adhesive layers are bonded to one another. For example, the second adhesive layer 32 bonds the first adhesive layer 31 and the third adhesive layer 33, and the third adhesive layer 33 bonds the second adhesive layer 32 and the second glass plate 20. And, the adhesive interlayer 30 has the second adhesive surface 42 as an adhesive surface between the second adhesive layer 32 and the third adhesive layer 33, the third adhesive surface 43 as an adhesive surface between the third adhesive layer 33 and the fourth adhesive layer 34, the fourth adhesive surface 44 as an adhesive surface between the fourth adhesive layer 34 and the fifth adhesive layer 35, and the fifth adhesive surface 45 as an adhesive surface between the fourth adhesive layer 34 and the fifth adhesive layer 35.

As shown in FIG. 5, in the uniform region C, each of the first adhesive surface 41 to the fifth adhesive surface 45 is substantially in parallel with the first glass plate 10 and the second glass plate 20. Whereas in the nonuniform region D, the adhesive interlayer 30 partly has no first adhesive surface 41, second adhesive surface 42, fourth adhesive surface 44 and fifth adhesive surface 45. At that portion, the adhesive interlayer 30 has an adhesive surface between the first adhesive layer 31 and a third adhesive surface 43. The fourth adhesive layer 34 is in contact with the second glass plate 20. The adhesive interlayer 30 may partly have a smaller number of adhesive layers in the nonuniform region D than in the uniform region C. In the nonuniform region D, the adhesive interlayer 30 may not partly have a predetermined adhesive surface. Thus, the adhesive interlayer 30 may be a portion not having the first adhesive surface 41 to the fifth adhesive surface 45 in this order.

In the nonuniform region D, each of the first adhesive surface 41 to the fifth adhesive surface 45 is not in parallel (that is it forms an angle exceeding 10°) with the first glass plate 10 and the second glass plate 20. In the example shown in FIG. 5, in the nonuniform region D, each of the first adhesive surface 41 to the fifth adhesive surface 45 at least partly inclines by 10° or more toward the second glass plate 20 side around the center of the nonuniform region D. However, the shape is not limited thereto so long as at least one of the first adhesive surface 41 to the fifth adhesive surface 45 is not in parallel with the first glass plate 10 and the second glass plate 20. Further, the first adhesive surface 41 to the fifth adhesive surface 45 may have any cross sectional shape exemplified for the first adhesive surface 41 in the laminated glass 100.

### Second Embodiment

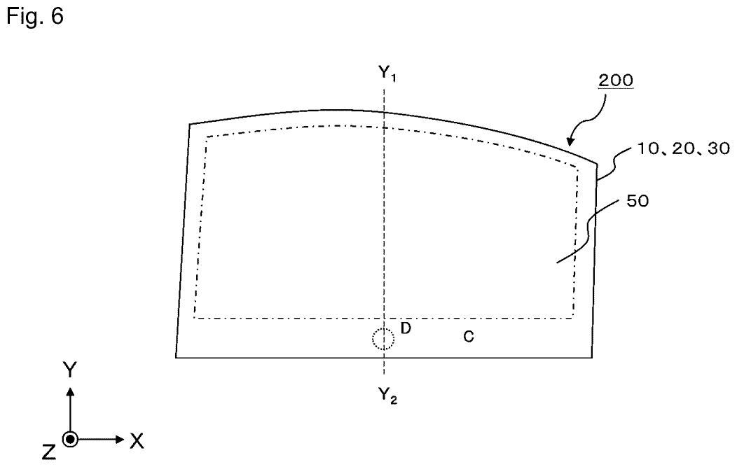

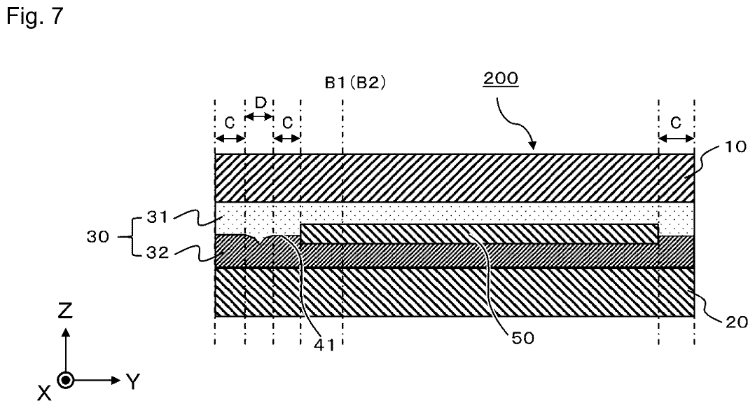

Now, a second embodiment will be described with reference to FIGS. 6 and 7. FIG. 6 is a plan view illustrating a laminated glass according to the second embodiment of the present invention. FIG. 7 is a crosse sectional view of the laminated glass 200 in FIG. 6 cut in YZ plane at the position Y₁-Y₂ in FIG. 6, as viewed from X-axis direction (hereinafter sometimes referred to as “Y1-Y2 cross section”). In the present embodiment, points different from the laminated glass 100 according to the first embodiment will be described, and regarding the other points, the descriptions of the first embodiment are incorporated. The laminated glass 200 is different from the laminated glass 100 in that the adhesive interlayer 30 has a functional member 50 in addition to the first adhesive layer 31 and the second adhesive layer 32.

In the laminated glass 200 in FIG. 6, the adhesive interlayer 30 is partitioned into the nonuniform region D, the uniform region C outside the nonuniform region D, and other region. Specifically, the uniform region C is a region excluding the nonuniform region D, in a region from the periphery of the first glass plate 10 and the second glass plate 20 to the periphery of the functional member 50. In the example shown in FIG. 6, the entire periphery of the nonuniform region D is surrounded by the uniform region C. The other region is a region having the functional member 50 (inside the alternate long and short dash line) in a plan view.

The functional member 50 is a layered member having at least one function of changing a visible light transmittance or haze, light emission, heat generation, infrared shielding, ultraviolet shielding, forming an image projected from an external light source, and reflection of p-polarized light. The functional member 50 is provided preferably in a region out of the nonuniform region D so as not to impair its function. In the laminated glass 200, the functional member 50 is provided in a region out of the uniform region C and out of the nonuniform region D (that is in the other region). However, in a case where the adhesive interlayer 30 includes three or more adhesive layers, the functional member 50 may be provided in the uniform region C.

In the uniform region C and the nonuniform region D, the bonding form of the first adhesive layer 31 and the second adhesive layer 32 (in a cross section) may be the same as in the laminated glass 100.

### Third Embodiment

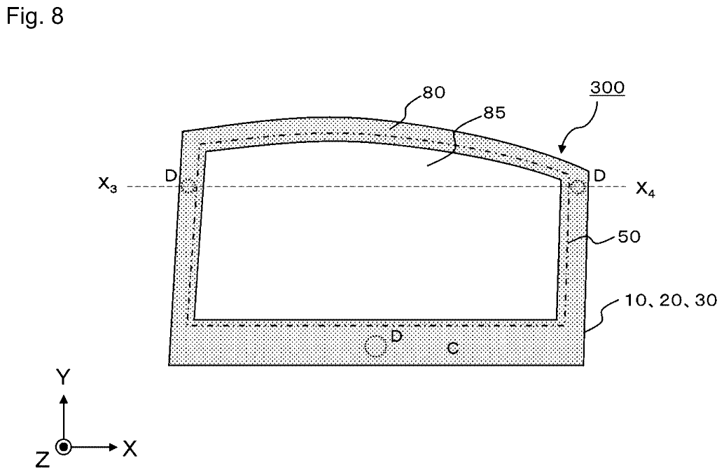

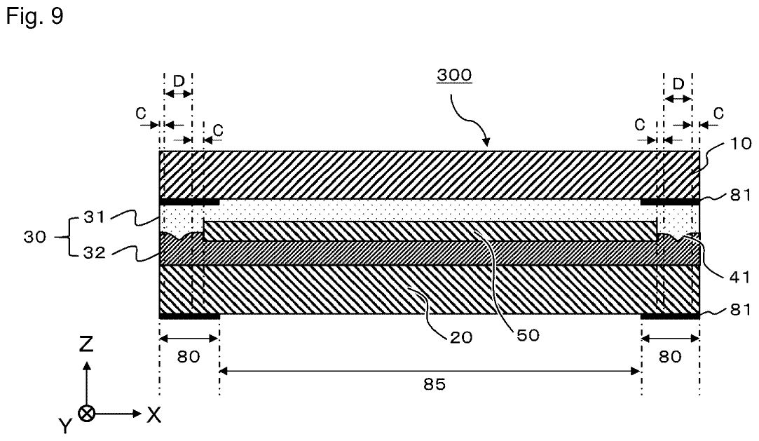

Now, a third embodiment will be described with reference to FIG. 8 to FIG. 9. FIG. 8 is a plane view illustrating a laminated glass according to the third embodiment of the present invention. FIG. 9 is a crosse sectional view of the laminated glass 300 in FIG. 8 cut in XZ plane at the position X3-X4 in FIG. 8, as viewed from Y-axis direction (hereinafter sometimes referred to as “X3-X4 cross section”). In the present modified example, points different from the laminated glass 200 according to the second embodiment will be described, and regarding the other points, the descriptions in the second embodiment are incorporated. The laminated glass 300 is different from the laminated glass 200 in that it has a shielding portion 80 at its peripheral region and has a plurality of nonuniform regions D.

As shown in FIG. 8, the laminated glass 300 according to the present embodiment has a shielding portion 80 indicated by half-tone dot meshing with a predetermined width from the periphery of the first glass plate 10 and the second glass plate 20. The shielding portion 80 can prevent an adhesive such as a urethane resin to be used for bonding the laminated glass 300 to a vehicle, from being deteriorated e.g. by ultraviolet rays. It can also shield a portion where the laminated glass is attached to e.g. a frame of a vehicle, a wire conductor, etc. The shielding portion 80 may be provided only at a part of the periphery of the first glass plate 10 and the second glass plate 20. It may be provided on the laminated glass 300 by other method described later.

The laminated glass 300 has an opening 85 inside the shielding portion 80 in a plan view. The opening 85 is a region through which when the laminated glass 300 is mounted in a vehicle, the outside of the vehicle can be seen from the inside of the vehicle. The periphery of the functional member 50 overlaps the shielding portion 80, whereby the periphery of the functional member 50 is not seen from at least one of the inside and the outside of the vehicle.

The nonuniform region D is provided preferably at a position overlapping the shielding portion 80 in a plan view, whereby the distortion will hardly be recognizable. In the example shown in FIG. 8, the laminated glass 300 has three nonuniform regions D at positions overlapping the shielding portion 80. Specifically, the laminated glass 300 has one nonuniform region D on each of the left and right side edge (the edge extending in Y-axis direction) portions of the laminated glass 300, and one nonuniform region D at the lower edge (the edge extending in X-axis direction) portion of the laminated glass 300. However, the positions of the plurality of nonuniform regions D are not limited thereto. For example, there may be one nonuniform region D on each of the upper and lower edge portions or may be one nonuniform region D on each of the left and right side edge portions, or the positions may be a combination thereof. Further, the laminated glass 300 may have two or more nonuniform regions D on one edge portion. In the example shown in FIG. 8, at the side edge portions of the laminated glass 300, the width of the shielding portion 80 is narrower than in the lower edge portion. And, the widths of the two nonuniform regions D on the side edge portions of the laminated glass 300 are narrower than the width of the one nonuniform region D on the lower edge portion.

In a case where the laminated glass 300 is used for a slidable window glass, a lower end portion (not shown) commonly called beltline, visible from the inside of the vehicle in a state where the window is completely closed, can be defined. In this case, the nonuniform region D is provided preferably below the belt line (that is on the peripheral side of the glass plate than the belt line), whereby the nonuniform region D is hardly recognizable.

In the example in FIG. 9, the shielding portion 80 includes two shielding layers 81. One of the two shielding layers 81 is provided on the main surface closer to the functional member 50 among the main surfaces of the first glass plate 10. The other shielding layer 81 is provided on the main surface farther from the functional member 50 among the main surfaces of the second glass plate 20. However, the shielding portion 80 may have only one of the shielding layers 81. In a case where the glass plate is curved, the shielding layer is provided usually on the concave surface. In other words, when the laminated glass is mounted in a vehicle, the shielding layer 81 is provided preferably on the main surface on the vehicle interior side of at least one of the first glass plate 10 and the second glass plate 20.

Only the laminated glass 300 according to the present embodiment has the shielding portion 80 and the shielding layer 81, but the laminated glass according to another embodiment or a modified example thereof may have the shielding portion 80 and the shielding layer 81.

The laminated glasses 100 to 300 according to the embodiments of the present invention have been described above with reference to FIG. 1 to FIG. 9. The laminated glasses 100 to 300 may have more than two glass plates as the case requires. For example, the laminated glasses 100 to 300 may have a third glass plate, or the laminated glasses 100 to 300 may be a laminate having the first glass plate 10, the adhesive interlayer 30, the second glass plate 20, the adhesive interlayer 30 and the third glass plate laminated in this order.

### <Constituents>

Now, constituents in the laminated glasses 100 to 300 according to the embodiments of the present invention will be described in further detail. For simplification, explanation is made with reference to the laminated glass 100, for the laminated glasses 100 to 300, but the following explanation of the constituents is applicable also to the laminated glass 110 to 300. Thus, to represent the constituents, the reference symbols used in FIG. 1 to FIG. 9 are employed.

### <Glass Plate>

The shape of each of the first glass plate 10 and the second glass plate 20 may be optional and is preferably, for example, substantially rectangular, substantially trapezoidal or substantially triangular. The first glass plate 10 and the second glass plate 20 may be flat but it is preferred that at least one of them is curved, and it is more preferred that both are curved. Each of the first glass plate 10 and the second glass plate 20 may be mono-curved (cylindrical) such that the plate is curved only in one direction or may be double curved such that the plate is curved in two orthogonal directions.

In the laminated glass 100, the radius of curvature of the first glass plate 10 and the radius of curvature of the second glass plate 20 may be substantially the same (including a case where both are flat) or different from each other. For example, the radius of curvature of the first glass plate 10 may be larger than the radius of curvature of the second glass plate 20. That is, the ratio of the smallest radius of curvature (R2) of the second glass plate 20 to the smallest radius of curvature (R1) of the first glass plate 10 may be 1≤R1/R2. In this case, the convex surface of the first glass plate 10 and the concave surface of the second glass plate 20 face each other. On the other hand, when 1>R1/R2, the concave surface of the first glass plate 10 and the convex surface of the second glass plate 20 face each other.

In a case where R1 and R2 are substantially the same, either of the first glass plate 10 and the second glass plate 20 may be disposed on the vehicle interior side/vehicle exterior side. In a case where R1 and R2 are different from each other, in order to prevent the glass plates from being brought into contact with each other to cause distortion at the time of production, it is preferred that the glass plate corresponding to the larger one of R1 and R2 is disposed on the vehicle interior side and the glass plate corresponding to the smaller one on the vehicle exterior side. That is, for example in a case where R2<R1, the first glass plate 10 is disposed preferably on the vehicle interior side and the second glass plate 20 on the vehicle exterior side.

For the first glass plate 10 and the second glass plate 20, conventional inorganic glass or organic glass to be used for a vehicle window glass may be selected. The composition of the first glass plate 10 and the composition of the second glass plate 20 may be the same or different. As the inorganic glass, soda lime glass, aluminosilicate glass, borosilicate glass, alkali free glass, quartz glass, etc. may be used without any particular restriction.

The glass plate to be positioned on the vehicle exterior side of the laminated glass 100 is preferably inorganic glass from the viewpoint of scratch resistance, and preferably soda lime glass from the viewpoint of forming property. In a case where the glass plate is formed of soda lime glass, clear glass, green glass having a certain iron content or more, and UV cut green glass may suitably be used. A UV cut green glass plate means ultraviolet absorbing green glass having a SiO₂ content of 68 mass % or more and 74 mass % or less, a Fe₂O₃ content of 0.3 mass % or more and 1.0 mass % or less and a FeO content of 0.05 mass % or more and 0.5 mass % or less, having an ultraviolet transmittance at a wavelength of 350 nm of 1.5% or more, and having a minimum value of the transmittance in a region of 550 nm or more and 1700 nm or less.

They may be produced by an optional known method such as float process, fusion process, roll out process or downdraw method. To bend inorganic glass, gravity forming, press forming, roller forming, etc., may be employed, and the glass plate is bent at about 550° C. to 770° C. Inorganic glass may be non-tempered glass obtained by forming molten glass into a plate, followed by annealing, or may be tempered e.g. by physical tempering (for example by air cooling) or chemical tempering as the case requires.

Organic glass may be a transparent resin such as a polycarbonate resin, an acrylic resin, a polystyrene resin, an aromatic polyester resin, a polyester resin, a polyarylate resin, a polycondensate of halogenated bisphenol A and ethylene glycol, an acrylic urethane resin or a halogenated aryl group-containing acrylic resin. The organic glass is preferably a polycarbonate resin, whereby a light-weight and flexible sheet can be obtained. The resins may be used in combination of two or more.

The first glass plate 10 and the second glass plate 20 are more preferably float glass. Float glass is usually preferably soda lime glass, but in order to transmit electric waves at a predetermined frequency, alkali free glass may be used.

Each of inorganic glass and organic glass is usually colorless but may be colored so long as it has transparency. In a case where it is colored, it may be so-called privacy glass, having a dark color such as gray. The privacy glass may be described in detail for example in WO2015/088026, and the content thereof may be incorporated herein by reference. The privacy glass has effects such that transmission of sunlight from the outside of the vehicle to the inside of the vehicle is decreased and the appearance from the inside and the outside of the vehicle is improved, while the inside of the vehicle is less likely to be seen from the outside of the vehicle.

The privacy glass is used suitably for a portion other than the windshield, particularly for the roof, the side window at the back of the vehicle, the rear window, etc. Inorganic glass and organic glass may have infrared absorption function and ultraviolet absorption function.

The thicknesses of the first glass plate 10 and the second glass plate 20 may properly be selected depending upon the type and the portion of a vehicle to which the laminated glass 100 is to be used, and are usually 0.1 mm to 10 mm respectively. Hereinafter, the thicknesses of the first glass plate 10 and the second glass plate 20 will be described with reference to a case where when the laminated glass 100 is mounted in a vehicle, the first glass plate 10 is disposed on the vehicle interior side and the second glass plate 20 is disposed on the vehicle exterior side. In a case where there is distribution of the thickness of the glass plate, the thickness at the thinnest portion is taken as the thickness.

The thickness of the first glass plate 10 is, in view of flying stone resistance, preferably 0.3 mm or more, more preferably 0.5 mm or more, further preferably 0.7 mm or more, particularly preferably 1.1 mm or more, most preferably 1.6 mm or more. Further, in order to suppress the mass of the laminated glass 100, the thickness of the first glass plate 10 is preferably 3 mm or less, more preferably 2.6 mm or less, further preferably 2.1 mm or less.

The same applies to the second glass plate 20 as for the first glass plate 10. The second glass plate 20 may have a composition different from the first glass plate 10. The second glass plate 20 may have a thickness different from the first glass plate 10.

In a case where the first glass plate 10 and the second glass plate 20 have different thicknesses, the glass plate on the vehicle exterior side is preferably thicker than the glass plate on the vehicle interior side, in view of flying stone resistance. The difference between the thickness of the first glass plate 10 and the thickness of the second glass plate 20 is preferably 0.3 to 1.5 mm, more preferably 0.5 mm to 1.3 mm.

At least one of the first glass plate 10 and the second glass plate 20 may have a coating to import water repellency, hydrophilicity, anti-fouling function, fingerprint-preventing function, anti-fogging function, electrically heating function, infrared absorbing/reflecting function, ultraviolet absorbing/reflecting function, low emission property, low reflection property, coloring, etc., formed on its main surface. Such a coating may be used alone or in combination of two or more. Instead of the coating, a film having the same function or property may be bonded to the main surface of the glass plate.

It is preferred to provide a coating to impart water repellency, hydrophilicity or anti-fouling function on the main surface of the glass plate on the most vehicle exterior side, when mounted in a vehicle, among the first glass plate 10 and the second glass plate 20. It is preferred to provide, on at least one of the facing main surfaces (main surfaces on the adhesive interlayer 30 side) of the first glass plate 10 and the second glass plate 20, a coating to impart electrically heating function, infrared absorbing/reflecting function, ultraviolet absorbing/reflecting function or coloring. Particularly a coating to impart infrared absorbing/reflecting function or ultraviolet absorbing/reflecting function is preferably provided on the main surface on the vehicle interior side of the glass plate positioned on the vehicle exterior side (for example the second glass plate 20). It is preferred to provide a coating to impart fingerprint-preventing function, anti-fogging function, electrically heating function, infrared absorbing/reflecting function, low emission property, low reflection property or coloring on the main surface of the glass plate on the most vehicle interior side, when mounted in a vehicle, among the first glass plate 10 and the second glass plate 20.

### <Shielding Portion>

The shielding portion 80 needs to block visible light to such an extent that at least a portion required to be shielded, can be shielded. The shielding portion 80 includes an opaque shielding layer 81. The shielding layer 81 may be constituted e.g. by an organic ink, a colored ceramic or a colored film. The colored film may be a resin sheet which can be used also as an adhesive layer, or may be a resin sheet unsuitable as an adhesive layer such as PET. The shielding layer 81 may be in any color such as white, gray, black, brown or navy blue, preferably dark color, more preferably black. The shielding layer 81 may have shades of colors as the case requires, so long as it can fulfil its function. In the shielding portion 80, a dot pattern or line pattern may be formed by the shielding layer 81, so that the visible light transmission degree can readily be adjusted by setting the shape, the disposition, etc.

The width of the shielding portion 80 may properly be selected depending upon the application of the laminated glass. For example, in a case where the laminated glass is used for roof glass used at the ceiling of an automobile, the shielding portion 80 is formed into a frame having a width of usually about 10 mm to 200 mm. Further, in a case where it is used for side glass of an automobile, it may sometimes be formed into a strip having a width of about 5 mm to 100 mm.

The thickness of the shielding layer 81 is not particularly limited and may, for example, be within a range of 1 μm to 200 μm, preferably 5 μm to 150 μm. In a case where the shielding layer 81 is constituted by an organic ink or a colored ceramic, the thickness of the shielding layer 81 is more preferably 5 μm to 30 μm.

The shielding portion 80 may be constituted by using the adhesive interlayer 30 of which a predetermined range is colored. For example, at least one adhesive layer included in the adhesive interlayer 30 may be colored or have a color print on its surface.

### <Adhesive Interlayer and Adhesive Layer>

The adhesive interlayer 30 includes at least two adhesive layers to bond the glass plates. Each adhesive layer is provided as a resin sheet prior to the step of heating and pressurizing an assembly to bond the glass plates described later.

As the resin sheet, thermoplastic resins are often used, and thermoplastic resins that have been used for this type of application, for example, plasticized polyvinyl acetal resins, plasticized polyvinyl chloride resins, saturated polyester resins, plasticized saturated polyester resins, polyurethane resins, plasticized polyurethane resins, ethylene/vinyl acetate copolymer resins, ethylene/ethyl acrylate copolymer resins, cycloolefin polymer resins, ionomer resins, etc., may be mentioned. Further, a resin composition containing a modified block copolymer hydride as described in Japanese Patent No. 6065221 may also be suitably used.

Among these, plasticized polyvinyl acetal resins are suitably used, because they are excellent in balance of various properties such as transparency, weather resistance, strength, adhesion, penetration resistance, impact energy absorption, moisture resistance, heat insulation, and sound insulation property. These thermoplastic resins may be used alone, or two or more of them may be used in combination. The term “plasticized” in the above plasticized polyvinyl acetal resins means that they are plasticized by the addition of a plasticizer. The same applies to other plasticized resins.

However, when a certain object is to be sealed in the adhesive interlayer 30, depending on the type of the material to be sealed, it may be degraded by a certain plasticizer, and in such a case, it is preferred to use a resin which contains substantially no such a plasticizer. As the resin containing no plasticizer, for example, an ethylene/vinyl acetate copolymer (EVA) resin or the like may be mentioned.

As the above plasticized polyvinyl acetal resins, a polyvinyl formal resin obtainable by reacting polyvinyl alcohol (PVA) with formaldehyde, a polyvinyl acetal resin in the narrow sense obtainable by reacting PVA with acetaldehyde, a polyvinyl butyral (PVB) resin obtainable by reacting PVA with n-butyl aldehyde, etc. may be mentioned, and PVB is particularly suitable, since it is excellent in balance of various properties, such as transparency, weather resistance, strength, adhesion, penetration resistance, impact energy absorption, moisture resistance, heat insulation and sound insulation property. Further, these plasticized polyvinyl acetal resins may be used alone or in combination of two or more of them.

However, the material for forming the resin sheet is not limited to a thermoplastic resin. The resin sheet may contain functional particles such as infrared absorbers, ultraviolet absorbers, luminescent agents, etc. Further, the resin sheet may have a colored portion called a shade band. The coloring pigment to be used for forming the colored portion, may be one that can be used for plastics, and the amount of addition may be adjusted so that the visible light transmittance of the colored portion will be 40% or less, and, for example, an organic color pigment of azo type, phthalocyanine type, quinacridone type, perylene type, perinone type, dioxazine type, anthraquinone type, or isoindolino type, or an inorganic color pigment such as an oxide, a hydroxide, a sulfide, a chromate, a sulfate, a carbonate, a silicate, a phosphate, an arsenate, a ferrocyanide, carbon or metal powder may be mentioned. These color pigments may be used alone or in combination of two or more of them.

In order that the adhesive interlayer 30 is sufficiently sheared to improve the sound insulation performance of the laminated glass, at least two adhesive layers are a combination of a layer having a glass transition point of 15° C. or higher (hereinafter sometimes referred to as “layer A”) and a layer having a glass transition point of less than 15° C. (hereinafter sometimes referred to as “layer B”). The layer A and the layer B are constituted by properly selecting a resin from thermoplastic resins as main materials constituting the adhesive interlayer commonly used for the laminated glass, so that the above glass transition point of each layer is achieved. So long as the above glass transition points are achieved, the type of the thermoplastic resin used is not particularly limited. Thermoplastic resins are known to be capable of adjusting the glass transition point by adjusting e.g. the content of the plasticizer.

The layer A and the layer B are preferably alternately laminated. Further, the adhesive interlayer 30 preferably includes two or more layers A. That is, the adhesive interlayer 30 preferably has a plurality of layer A/layer B/layer A structures. Specifically, such structures as layer A/layer B/layer A/layer A/layer B/layer A, layer A/layer B/layer A/layer B/layer A, layer A/layer B/layer A/layer A/layer B/layer A/layer A/layer B/layer A, and layer A/layer B/layer A/layer B/layer A/layer B/layer A may be mentioned, but the structure is not limited thereto. From the viewpoint of production of the resin sheet and easiness of lamination, the number of the layers B is preferably 5 or less. With such a structure, large shear energy occurs at several parts of the adhesive interlayer 30 due to oscillation energy of sound, which is released as heat energy, whereby sound insulation performance is achieved.

For example, in the laminated glass 120 in FIG. 4, when the layer A is used for the first adhesive layer 31 and the third adhesive layer 33 and the layer B is used for the second adhesive layer 32, a laminated glass excellent in sound insulation property will be obtained. Further, in the laminated glass 130 in FIG. 5, when the layer A is used for the first adhesive layer 31, the third adhesive layer 33, the fourth adhesive layer 34 and the sixth adhesive layer 36 and the layer B is used for the second adhesive layer 32 and the fifth adhesive layer 35, a laminated glass very excellent in sound insulation property will be obtained.

The glass transition point of the layer B is preferably 10° C. or below, more preferably 8° C. or below. When the layer B has a glass transition point of less than 15° C., the laminated glass has predetermined sound insulation performance. The layer B has a glass transition point of −10° C. or higher, more preferably 0° C. or higher with a view to keeping the shape of the layer B itself.

The glass transition point of the layer A is preferably 20° C. or higher, more preferably 25° C. or higher. By the layer A having a glass transition point of 15° C. or higher, the laminated glass has predetermined sound insulation performance. The glass transition point of the layer A is preferably 50° C. or below, more preferably 40° C. or below from the viewpoint of penetration resistance. With a view to improving sound insulation property, a value obtained by subtracting the glass transition point of the layer B from the glass transition point of the layer A is preferably 10° C. to 40° C., more preferably 20° C. to 35° C.

The thickness of the adhesive interlayer 30 means, in a case where the laminated glass has the functional member 50, a thickness of a portion excluding the functional member 50. That is it means the total thickness of the respective adhesive layers. The thinnest portion of the adhesive interlayer 30 indicates, for example, the portion including the functional member 50 (a portion overlapping the functional member 50 in a plan view). The thickest portion of the adhesive interlayer 30 indicates, for example, the portion not including the functional member 50 (a portion not overlapping the functional member 50 in a plan view). In a case where the laminated glass has no functional member 50, the adhesive interlayer 30 may have substantially uniform thickness regardless of the position. In such a case, the thinnest portion and the thickest portion of the adhesive interlayer 30 may be optional positions.

The thickness of the adhesive interlayer 30 is preferably 0.5 mm or more at the thinnest portion. When the thickness of the adhesive interlayer 30 at the thinnest portion is 0.5 mm or more, impact resistance required for the laminated glass 100 can be secured. From the viewpoint of sound insulation property, the thickness of the adhesive interlayer 30 at the thinnest portion is preferably 0.8 mm or more, more preferably 1.0 mm, further preferably 1.53 mm or more, particularly preferably 2.0 mm or more. Further, the thickness of the adhesive interlayer 30 at the thickest portion is preferably 4.0 mm or less. When the thickness of the adhesive interlayer 30 at the thickest portion is 4.0 mm or less, the mass of the laminated glass 100 will not be too large. The thickness of the adhesive interlayer 30 at the thickest portion may be 3.1 mm or less, and is preferably 2.8 mm or less, more preferably 2.6 mm or less.

The thickness of each adhesive layer, that is the thickness of the resin sheet, is preferably about 0.05 mm to 1.1 mm. The thickness of the resin sheet used as the layer A is preferably 0.15 mm to 1.1 mm, more preferably 0.2 mm to 0.76 mm, further preferably 0.2 mm to 0.45 mm. Further, the thickness of the resin sheet used as the layer B is preferably 0.05 to 0.2 mm, more preferably 0.07 to 0.15 mm. The thicknesses of the plurality of the layers A may be different, and the thicknesses of the plurality of the layers B may also be different.

The adhesive interlayer 30 has a storage elastic modulus G′ at a frequency of 1 Hz at a temperature of 20° C. of preferably 5.0×10⁴ Pa or higher, more preferably 1.0×10⁵ Pa or higher. The storage elastic modulus G′ is an indicator of rigidity, and when the storage elastic modulus G′ of the adhesive interlayer 30 is within the above range, rigidity can sufficiently be secured.

The upper limit of the storage elastic modulus G′ of the adhesive interlayer 30 is not particularly limited. However, if the storage elastic modulus G′ of the adhesive interlayer 30 is high, sound insulation performance of the laminated glass may be impaired. Further, if the storage elastic modulus G′ of the adhesive interlayer 30 is too high, special equipment may be required in processing such as cutting, and thus the productivity may decrease. Further, the adhesive interlayer 30 tends to be fragile and the penetration resistance decreases. Considering these points, the storage elastic modulus G′ of the adhesive interlayer 30 is preferably 1.0×10⁷ Pa or lower.

In this specification, the storage elastic modulus G′ of the adhesive interlayer 30 is a storage elastic modulus in dynamic elasticity measurement by shear method at a frequency of 1 Hz at a temperature of 20° C. at an amplitude gamma of 0.015%. The storage elastic modulus G′ may be measured, for example, by using a test specimen formed into a disc having a thickness of d=0.6 mm and a diameter of 12 mm under the above conditions with a measurement jig parallel plate (diameter 12 mm), by a dynamic viscoelasticity measurement apparatus. The dynamic viscoelasticity measurement apparatus may, for example, be rotary rheometer MCR301 manufactured by Anton Paar.

### [Laminated Glass]

Now, explanations will be made with reference to the laminated glass 100, but the explanations apply to the laminated glasses 110 to 300. In the laminated glass 100, at least one side, the plate misalignment amount between the first glass plate 10 and the second glass plate 20 is preferably less than 1.2 mm, more preferably 1 mm or less, further preferably 0.8 mm or less, further more preferably 0.6 mm or less, most preferably substantially 0 mm, meaning that there is no plate misalignment.

The plate misalignment amount between the first glass plate 10 and the second glass plate 20 on at least one side of the laminated glass 100 is preferably 1.5 mm or less, whereby the laminated glass can be mounted on an appropriate position of a vehicle and the appearance will not be impaired, and is more preferably 1.0 mm or less. It is more preferred that in the laminated glass 100, the plate misalignment amount on two or more sides is the above upper limit value or less, and it is further preferred that the plate misalignment amount on the entire periphery is the above upper limit value or less.

From the viewpoint of sound insulation property, of the laminated glass 100, the loss factor at the primary resonance point measured at a temperature of 20° C. in a frequency region of 0 Hz to 10,000 Hz is preferably 0.1 or more, more preferably 0.2 or more, further preferably 0.3 or more, further more preferably 0.4 or more, particularly preferably 0.42 or more, most preferably 0.45 or more. In the case of a curved laminated glass for example, the loss factor of a laminated glass prepared by using flat glass plates to have the same constitution as the curved laminated glass, may be measured. Hereinafter, the primary resonance point means a primary resonance point measured at a temperature of 20° C. in a frequency region of 0 Hz to 10,000 Hz unless otherwise specified.

The loss factor at the primary resonance point may be measured by central exciting method in accordance with ISO PAS 16940. As apparatus for measuring the loss factor by central exciting method, for example, central exciting measuring system (MA-5500, DS-2000) manufactured by Ono Sokki Co., Ltd. may be mentioned. The frequency region at the primary resonance point of the laminated glass of the present invention is approximately 0 Hz to 300 Hz. In the laminated glass of the present invention, when the loss factor at the primary resonance point is 0.4 or more, for example, sounds in a relatively low frequency region such as engine noise and tire vibration noise can sufficiently be blocked.

Further, of the laminated glass 100, the sound transmission loss in the coincidence region as measured in accordance with SAE J1400 is 35 dB, preferably 42 dB or more. When the sound transmission loss of the laminated glass is 35 dB or more, the laminated glass may be evaluated as having excellent sound insulation property.

### <Functional Member>

The functional member 50 is preferably transparent. The functional member 50 may be a layer driven by an electrode. The functional member 50 may be e.g. a light control layer, a light emitting layer or an electric heating layer driven by power supply from an electrode, and a portion thereof achieving a predetermined function driven by electric power as a whole constitutes a flat plane. The functional member 50 may be a layer to which an electrode is connected for a purpose other than power supply, such as a touch sensor. The functional member 50 may have a transparent screen film, a P-polarized reflecting film, an infrared cut film or an ultraviolet cut film, as a layer not electrically driven. The transparent screen film is a film forming an image projected from an external light source to be visible. The P-polarized reflecting film is a film of which the P-polarized light reflectance is 5% or more with the incident angle from the external light source being the Brewster angle. The infrared cut film and the ultraviolet cut film are a film having a coating to reflect/absorb infrared light or ultraviolet light on the surface of a substrate, or a film constituted such that the whole substrate achieves a predetermined function. The above electrically-driven layer and a layer not electrically driven may be used in combination.

The light control layer is a layer having a function to change a visible light transmittance or haze by electric drive. The light control layer may, for example, be a liquid crystal (LC) film, a suspended particle device (SPD) film, an electrochromic (EC) film or an electrokinetic (EK) film. Such a film has, for example, a layer containing a liquid crystal, suspended particles or the like between at least two substrate films, and is driven by power supply through an electrode provided on at least one of the substrate films. The liquid crystal (LC) film includes, for example, a polymer dispersed liquid crystal (PDLC) film or a guest-host liquid crystal (GHLC) film. The light control layer may be utilized also as a shade band.

The light control layer contains a material which emits light driven by electric power, and may, for example, be light emitting diode, organic light emitting diode (OLED), a laser or a display utilizing them. The light emitting layer may be utilized also as a display for direction instructions or attention attraction.

The electric heating layer contains one which generates heat driven by electric power, and may contain at least one of a metal, a metal oxide and a conductive polymer. The electric heating layer may have an optional shape and as an example of the shape, a thin film shape or a thin wire shape may be mentioned. The electric heating layer may, for example, be specifically an electrically heating film for anti-fogging or an electrically heating wire for ice melting.

The thickness of the functional member 50 may, for example, be 0.1 mm to 3 mm. When it is 0.1 mm or more, the functional member 50 will be excellent in handling efficiency, and when it is 3 mm or less, the functional member 50 will easily be included in the adhesive interlayer 30. The thickness of the functional member 50 may be 0.12 mm or more, and is preferably 0.2 mm or more, more preferably 0.3 mm or more, further preferably 0.5 mm or more. The thickness of the functional member 50 may be 2 mm or less, and is preferably 1 mm or less.

### Method for Producing Laminated Glass

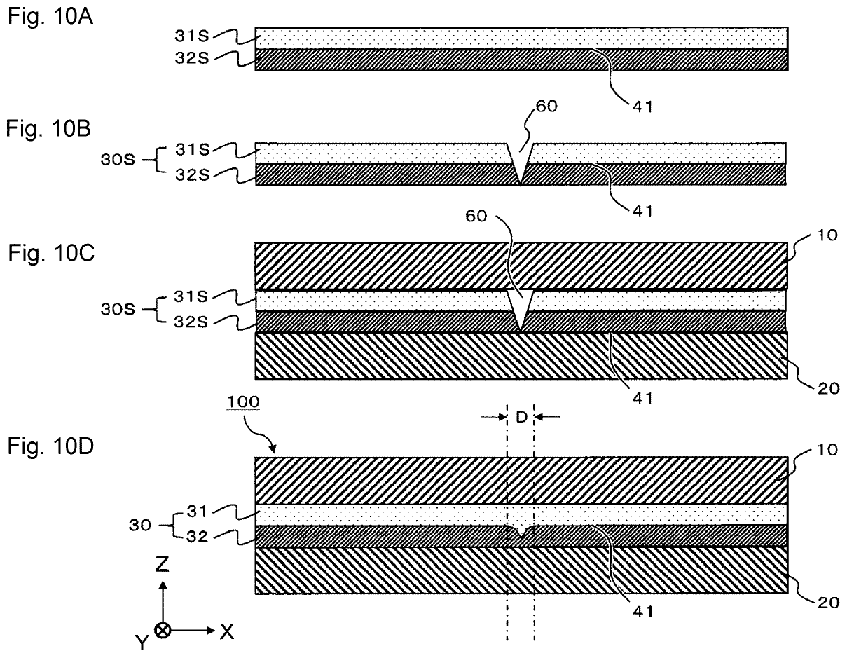

Now, a method for producing the laminated glass according to an embodiment of the present invention will be described with reference to FIG. 10A to FIG. 10D.

The method for producing the laminated glass 100 comprises step (a) of laminating two or more resin sheets, step (b) of temporarily bonding the two or more resin sheets laminated to prepare a composite resin sheet, step (c) of laminating the first glass plate, the composite resin sheet and the second glass plate in this order to prepare an assembly, and step (d) of heating and pressurizing the assembly to bond the first glass plate and the second glass plate.

Temporary bonding the resin sheets means partly bonding the two or more resin sheets laminated, and is different from bonding the glass plates. Since the resin sheets are not entirely bonded, winkles are less likely to form, and gas is likely to be release from between the resin sheets. The composite resin sheet means a structure having a plurality of resin sheets temporarily bonded. The assembly means a structure having a plurality of glass plates and the composite resin sheet laminated, and in the assembly, the glass plates are not bonded.

First, step (a) will be described. As shown in FIG. 10A, a first resin sheet 31S corresponding to the first adhesive layer 31 and a second resin sheet 32S corresponding to the second adhesive layer 32 are laminated. In a case where a laminated glass having three or more adhesive layers is to be produced, resin sheets corresponding to the respective adhesive layers are laminated. In a case where a laminated glass having a functional member is to be produced, the functional member is laminated between the two or more resin sheets. In FIG. 10A, the first resin sheet 31S is laminated on the second resin sheet 32S, but the order may be opposite. After the two or more resin sheets are laminated, their position may be adjusted as the case requires.

Now, step (b) will be described. Step (b) includes step (b-1) of heating a predetermined position of the two or more resin sheets laminated and step (b-2) of forming a hole 60 at the predetermined position. Either step (b-1) or step (b-2) may be conducted first, or they may be conducted simultaneously, but plate misalignment may more effectively be suppressed by conducting step (b-1) first or by conducting step (b-1) and step (b-2) simultaneously. By step (b), the nonuniform region D shown in FIG. 10D is formed.

The heating method in step (b-1) is not particularly limited, and for example, hot air blowing or contact with a heated jig may be employed. As a heating apparatus which may be used for the above heating, for example, a heater, a heat gun, an iron or a soldering iron may be mentioned.

In the above heating method, the heating temperature is a temperature equal to or higher than the softening point of the resin sheet. In a case where the softening point of the first resin sheet 31S and the softening point of the second resin sheet 32S are different, the heating temperature is a temperature equal to or higher than the highest softening point. The heating temperature may be set in the same manner when three or more resin sheets are used. A specific heating temperature is, in a case of PVB for example, usually about 60° C. to 110° C. although it depends on e.g. the amount of the additive. If the heating temperature exceeds 110° C., the resin sheets heated in step (c) will be bonded to the glass plates firmly. That is, the position of the composite resin sheet and the glass plates will hardly be adjusted, whereby plate misalignment is likely to occur. Further, if the resin sheet is exposed to high temperature, it may be oxidatively deteriorated by heat.

The heating time varies depending upon the heating method, and in a case where a heated jig is brought into contact, it may be about 0.5 seconds to 10 seconds. When it is 0.5 seconds or more, regardless of the order of step (b-1) and step (b-2), temporary bonding can appropriately be conducted. When it is 1 second or more, a variation in the quality tends to be reduced. When it is 10 seconds or less, a heating region described later will not excessively be wide, and oxidative destruction is less likely to occur. The heating time may, for example, be 8 seconds or less, and is preferably 6 seconds or less, more preferably 5 seconds or less, particularly preferably less than 5 seconds.

Hereinafter a portion to be heated of the two or more resin sheets laminated in a plan view will be referred to as a heating region. The shape of the heating region may be an optional shape. For example, substantially circular, substantially rectangular, substantially triangular and substantially star shapes may be mentioned. The size (the maximum distance between edges) of the heating region may, for example, be 0.1 mm to 20 mm. When the size of the heating region is larger than 0.1 mm, the strength in temporary bonding can be increased. When it is 20 mm or less, the region in which embossing provided on the resin sheet surface disappears will be narrow, and gas will be well released in step (d). A preferred range of the size of the heating region is the same as the preferred range of the width of the nonuniform region D in the laminated glass 100 according to the first embodiment.

The position of the heating region may be a position corresponding to the position of the nonuniform region D in the laminated glasses 100 to 300. The number of the heating region may be the number corresponding to the number of the nonuniform region D and may be one or more. However, the distance between a plurality of heating regions is preferably 20 mm or more, more preferably 50 mm or more, further preferably 100 mm or more, still more preferably 150 mm or more, whereby the gas will be well released.

The method of forming a hole 60 on the resin sheet in step (b-2) is not particularly limited, and for example, a jig with a sharp tip may be used. Use of a heatable metal body with a sharp tip, such as a soldering iron, is preferred, whereby step (b-1) and step (b-2) can be conducted simultaneously.

The position and the size of the hole 60 to be formed on the resin sheet may be substantially the same as the position and the size of the heating region. However, according to the above described method, the size of the hole 60 is slightly smaller than the size of the heating region.

The hole 60 to be formed on the resin sheet may be a though hole or a non-through hole. In FIG. 10B, a hole 60 is formed from the first resin sheet 31S toward the second resin sheet 32S, but the hole may be formed in the opposite direction. Both a hole 60 from the first resin sheet 31S toward the second resin sheet 32S and a hole 60 from the second resin sheet 32S toward the first resin sheet 31S may be provided. In FIG. 10B, the hole tapers toward the second resin sheet 32S, but is not limited thereto.

The hole 60 must pass the interface between the resin sheets to be temporarily bonded. For example, in FIG. 10B, a hole 60 may be provided which passes the interface from the first resin sheet 31S to the second resin sheet 32S. In a case where three or more resin sheets are laminated, a hole should be provided so as to pass two or more interfaces. One hole may pass the two or more interfaces, or two or more holes may be combined to pass the two or more interfaces. Depending upon the way of forming the holes, the shape of the adhesive surface between adhesive layers after step (d) varies.

By step (b) including both step (b-1) and step (b-2), the bond strength can be secured, and an unnecessary spread of the heating region can be suppressed and gas releasability can be improved. In step (b-2), on the surface of the hole 60, fine engagement between the plurality of resin sheets occurs (not shown), whereby the adhesion can be improved. In a case where step (b-1) and step (b-2) are conducted simultaneously, fine fragments of the resin sheet chipped off the hole in step (b-2) enter between the resin sheets and the fragments heated give adhesion, whereby temporary bonding strength is likely to improve. Thus, plate misalignment caused by slippage of the resin sheets can be suppressed.

As described above, by step (b) including step (b-1) and step (b-2), the two or more resin sheets laminated are temporarily bonded at a predetermined region, whereby a composite resin sheet 30S can be prepared.

Now, step (c) will be described. Step (c) is a step of preparing an assembly having the composite resin sheet 30S laminated between a plurality of glass plates. As shown in FIG. 10C, the first glass plate 10, the composite resin sheet 30S and the second glass plate 20 are laminated in this order to prepare an assembly. For example, in a case where the composite resin sheet 30S is prepared on the second glass plate 20 in the above step (b), the first glass plate 10 is further laminated. In step (c), either of the first glass plate 10 or the second glass plate 20 may be placed on the bottom side. After step (c), the composite resin sheet 30S protruding from at least one of the first glass plate 10 and the second glass plate 20 may optionally be trimmed off. Since the composite resin sheet 30S prepared in step (b) has high temporary bonding strength, the resin sheets are less likely to be misaligned even if trimmed.

Now, step (d) will be described. Step (d) may be conducted by a commonly employed know technique. For example, the assembly prepared in step (c) may be pressure-bonded in the next step (d-1). Step (d-1): the assembly is put in a rubber bag, a rubber channel or a resin bag and pressure-bonded in vacuum with a pressure controlled to a gauge pressure of −100 kPa or more and −65 kPa or less at a temperature controlled to be about 70° C. or higher and 120° C. or below. Otherwise, the assembly may be made to pass through nip rolls to apply the corresponding pressure to the assembly. The heating conditions and the temperature conditions may suitably be selected. As the case requires, step (d) may include step (d-2) after step (d-1). Step (d-2): pressure-bonding treatment of heating and pressurizing the assembly under conditions where the absolute pressure is 0.6 mPa or higher and 1.3 mPa or lower and the temperature is 100° C. or higher and 150° C. or below. By step (d-2), a laminated glass 100 excellent in durability is obtained.

### EXAMPLES

Now, the present invention will be described in further detail with reference to Examples, but the present invention is by no means restricted thereto. As described below, laminated glasses having constitutions shown in Ex. 1 to 10 were prepared. Ex. 1 to 3 and 5 to 7 are Examples of the present invention, and Ex. 4 and 8 to 10 are Comparative Examples.

### Ex. 1

Ex. 1 is an example corresponding to the laminated glass 130 in modified example 3 according to the first embodiment. As the first glass plate 10 and the second glass plate 20, 300 mm square soda lime glass flat plates with a thickness of 2 mm were respectively used. As the resin sheet constituting the adhesive interlayer 30, a 300 mm square PVB sheet having a total thickness of 1.52 mm was used. The PVB sheet was a six-layered resin sheet having layers A with a thickness of 0.33 mm and a glass transition point of 30° C. and layers B with a thickness of 0.1 mm and a glass transition point of 3° C. laminated in the order of layer A/layer B/layer A/layer A/layer B/layer A.

To one point on the six-layered resin sheet having layer A/layer B/layer A/layer A/layer B/layer A laminated in this order, a soldering iron preheated to 100° C. was pressed for 3 seconds to form a through hole from one side to the opposite side thereby to obtain a composite resin sheet 30S. The composite resin sheet 30S was laminated between the first glass plate 10 and the second glass plate 20 to obtain an assembly. The assembly was put in a rubber bag and pressure-bonded in vacuum with a pressure controlled to a gauge pressure of −100 kPa or more and −65 kPa or less at a temperature controlled to be about 70° C. or higher and 120° C. or below. Finally, the assembly was heated and pressurized under conditions where the absolute pressure was 0.6 mPa or higher and 1.3 mPa or lower and the temperature was 100° C. or higher and 150° C. or below to obtain a laminated glass in Ex. 1.

### Ex. 2

A laminated glass in Ex. 2 was obtained in the same manner as in Ex. 1 except that the soldering iron was pressed against the resin sheet for 4 seconds.

### Ex. 3

A laminated glass in Ex. 3 was obtained in the same manner as in Ex. 1 except that the soldering iron was pressed against the resin sheet for 5 seconds.

### Ex. 4

A laminated glass in Ex. 4 was obtained in the same manner as in Ex. 1 except that neither step of heating the resin sheet nor step of forming a hole was conducted, and no composite resin sheet 30S was prepared. That is, the six-layered resin sheet was laminated as it was between the first glass plate 10 and the second glass plate 20 to obtain an assembly and then a laminated glass was prepared.

### Ex. 5

As the resin sheet constituting the adhesive interlayer 30, a 300 mm square PVB sheet having a total thickness of 2.28 mm was used. The PVB sheet was a nine-layered resin sheet having layers A with a thickness of 0.33 mm and a glass transition point of 30° C. and layers B with a thickness of 0.1 mm and a glass transition point of 3° C. laminated in the order of layer A/layer B/layer A/layer A/layer B/layer A/layer A/layer B/layer A. Except for the above, a laminated glass in Ex. 5 was obtained in the same manner as in Ex. 1.

### Ex. 6

A laminated glass in Ex. 6 was obtained in the same manner as in Ex. 5 except that the soldering iron was pressed against the resin sheet for 4 seconds.

### Ex. 7

A laminated glass in Ex. 7 was obtained in the same manner as in Ex. 5 except that the soldering iron was pressed against the resin sheet for 5 seconds.

### Ex. 8

A laminated glass in Ex. 6 was obtained in the same manner as in Ex. 5 except that neither the step (b-1) of heating the resin sheet nor the step (b-2) of forming a hole was conducted, and no composite resin sheet 30S was prepared. That is, the nine-layered resin sheet was laminated as it was between the first glass plate 10 and the second glass plate 20 to obtain an assembly and then a laminated glass was prepared.

### Ex. 9

As the resin sheet constituting the adhesive interlayer 30, a two-layered resin sheet having two 300 mm square PVB sheets with a thickness of 0.76 mm and a glass transition point of 30° C. laminated was used. Further, neither step of heating the resin sheet nor step of forming a hole was conducted, and no composite resin sheet 30S was prepared. Except for the above, a laminated glass in Ex. 9 was obtained in the same manner as in Ex. 1. That is, the two-layered resin sheet was laminated as it was between the first glass plate 10 and the second glass plate 20 to obtain an assembly and then a laminated glass was prepared.

### Ex. 10

A laminated glass in Ex. 10 was obtained in the same manner as in Ex. 9 except that as the resin sheet constituting the adhesive interlayer 30, a three-layered resin sheet having three 300 mm square PVB sheets with a thickness of 0.76 mm and a glass transition point of 30° C. was used.

The laminated glasses in Ex. 1 to 10 were evaluated with respect to the following items. The constitution of each laminated glass and evaluation results are shown in Table 1.

### [Measurement of Width of Nonuniform Region]

Two pairs of laminated glasses in each of Ex. 1 to 3 and 5 to 7 were prepared. The laminated glasses were respectively cut so that the cut line passed the nonuniform region, and the cut surface was observed and measured with a microscope. As the width of the nonuniform region, the larger value among the measured values of the nonuniform regions of the two pairs of the laminated glasses was employed.

### [Evaluation of Plate Misalignment]

With respect to the laminated glasses in each of Ex. 1 to 10, the misalignment amount at the peripheries of the first glass plate and the second glass plate was measured and taken as the plate misalignment amount.

### [Evaluation of Bubble Resistance]

First, three pairs of the laminated glasses in each of Ex. 1 to 10 were prepared. The laminated glasses were heated respectively under the following three conditions (1) to (3). After heating, whether bubbles (air bubbles) were found in the nonuniform region or not was visually confirmed.

(1) at 120° C. for 2 hours, (2) at 130° C. for 1 hour, (3) at 140° C. for 1 hour

### [Evaluation of Sound Insulation Property]

With respect to the laminated glass in each of Ex. 1 to 10, the loss factor at the primary resonance point at a temperature of 20° C. in a frequency region of 0 Hz to 10,000 Hz was measured in accordance with ISO PAS 16940, using central exciting measuring system (MA-5500, DS-2000) manufactured by Ono Sokki Co., Ltd.

TABLE 1

| | Ex. 1 | Ex. 2 | Ex. 3 | Ex. 4 | Ex. 5 |
|---|---|---|---|---|---|
| Temporary bonding | 3 | 4 | 5 | Nil | 3 |
| heating time | Seconds | Seconds | Seconds | | Seconds |
| Width of nonuniform | 1.9 mm | 2.0 mm | 2.0 mm | Nil | 2.4 mm |
| region | | | | | |
| Plate misalignment | 0.6 mm | 0.6 mm | 0.6 mm | 1.2 mm | 0.7 mm |
| amount | | | | | |
| Bubbles | Nil | Nil | Nil | Nil | Nil |
| Primary loss factor | 0.4 | 0.4 | 0.4 | 0.4 | 0.47 |
| | Ex. 6 | Ex. 7 | Ex. 8 | Ex. 9 | Ex. 10 |
| Temporary bonding | 4 | 5 | Nil | Nil | Nil |
| heating time | Seconds | Seconds | | | |
| Width of nonuniform | 2.7 mm | 3.1 mm | Nil | Nil | Nil |
| region | | | | | |
| Plate misalignment | 0.7 mm | 0.7 mm | 1.4 mm | 1.2 mm | 1.4 mm |
| amount | | | | | |
| Bubbles | Nil | Nil | Nil | Nil | Ni |
| Primary loss factor | 0.47 | 0.47 | 0.47 | 0.04 | 0.06 |

The width of the nonuniform region was 1.9 mm to 2.0 mm in E. 1 to 3 and was 2.4 mm to 3.1 mm in Ex. 5 to 7. The width of the nonuniform region in Ex. 5 to 7 was large as compared with Ex. 1 to 3, but was within the acceptable range. The width of the nonuniform region tended to be large as the heating time for temporary bonding became longer.

In Ex. in which temporary bonding was conducted, the plate misalignment amount was small as compared with Ex. in which no temporary bonding was conducted. Thus, it was found that plate misalignment is suppressed by temporary bonding. Specifically, the plate misalignment amount of the laminated glass in each of Ex. 1 to 3 was 0.6 mm and such is favorable. The plate misalignment amount of the laminated glass in each of Ex. 5 to 7 was 0.7 mm and such is favorable. On the other hand, the plate misalignment amount of the laminated glass in each of Ex. 4 and 9 was 1.2 mm, and such is unsuitable. The plate misalignment amount of the laminated glass in each of Ex. 8 and 10 was 1.4 mm, and such is unsuitable.

In Ex. 1 to 3 and 5 to 7 in which temporary bonding was conducted, no bubbles were overserved in the same manner as in Ex. 4 and 8 to 10 in which no temporary bonding was conducted, and excellent adhesion and appearance were achieved.

The primary loss factor of the laminated glass in each of Ex. 1 to 8 was large as compared with that of the laminated glass in each of Ex. 9 to 10, thus indicating excellent sound insulation property. Specifically, the primary loss factor in Ex. 1 to 8 was 0.4 to 0.47, and was 0.04 to 0.06 in Ex. 9 to 10.

The preferred embodiment and the like were described above, but the present invention is by no means restricted to the above preferred embodiment and the like, and various modifications and replacement to the above embodiment and the like are possible without departing from the scope of the invention.

### REFERENCE SYMBOLS

10: first glass plate
20: second glass plate
30: adhesive interlayer
31: first adhesive layer
32: second adhesive layer
33: third adhesive layer
34: fourth adhesive layer
35: fifth adhesive layer
36: sixth adhesive layer
30S: composite resin sheet
31S: first resin sheet
32S: second resin sheet
41: first adhesive surface
42: second adhesive surface
43: third adhesive surface
44: fourth adhesive surface
45: fifth adhesive surface
50: functional member
60: hole
80: shielding portion
81: shielding layer
85: opening
C: uniform region
D: nonuniform region
100, 110, 120, 130, 200, 300: laminated glass

What is claimed is:

1. A laminated glass comprising a first glass plate, an adhesive interlayer and a second glass plate in this order,
wherein the adhesive interlayer comprises two or more adhesive layers and is partitioned into a uniform region and a nonuniform region,
the uniform region is a region positioned outside the nonuniform region in a plan view, containing only a portion in which the adhesive surface of any two adjacent adhesive layers is substantially in parallel with the first glass plate, and
the nonuniform region is a region including a portion in which the adhesive surface is not in parallel with the first glass plate.

2. The laminated glass according to claim 1, wherein the nonuniform region is positioned at a peripheral portion of the first glass plate in a plan view.

3. The laminated glass according to claim 1, wherein the adhesive interlayer comprises four or more adhesive layers.

4. The laminated glass according to claim 1, wherein the number of the adhesive layers of the adhesive interlayer is smaller in the nonuniform region than in the uniform region.

5. The laminated glass according to claim 1, wherein the two or more adhesive layers include a layer A having a glass transition point of 15° C. or higher and a layer B having a glass transition point of less than 15° C.

6. The laminated glass according to claim 5, wherein in the adhesive interlayer, the layer A and the layer B are alternately laminated, and two or more layers B are included.

7. The laminated glass according to claim 1, wherein the adhesive interlayer has a functional member in its interior.

8. The laminated glass according to claim 7, wherein the functional member is provided outside the nonuniform region.

9. The laminated glass according to claim 7, wherein the functional member is a layered member having at least one function of changing a visible light transmittance or haze, light emission, heat generation, infrared shielding, ultraviolet shielding, forming an image projected from an external light source, and reflection of P-polarized light.

10. The laminated glass according to claim 1, wherein the nonuniform region has a width of 20 mm or less in a plan view.

11. The laminated glass according to claim 1, which has a shielding portion on the peripheral portion of at least one of the first glass plate and the second glass plate, and the nonuniform region overlaps the shielding portion in a plan view.

12. The laminated glass according to claim 1, wherein the loss factor at the primary resonance point measured at a temperature of 20° C. in a frequency region of 0 Hz to 10,000 Hz is 0.1 or more.

13. A method for producing the laminated glass as defined in claim 1, comprising
step (a) of laminating two or more resin sheets,
step (b) of temporarily bonding the two or more resin sheets laminated to prepare a composite resin sheet,
step (c) of laminating the first glass plate, the composite resin sheet and the second glass plate in this order to prepare an assembly, and
step (d) of heating and pressurizing the assembly to bond the first glass plate and the second glass plate.

14. The method for producing the laminated glass according to claim 13, wherein step (b) includes step (b-1) of heating a predetermined position of the two or more resin sheets laminated and step (b-2) of forming a hole at the predetermined position.

15. The method for producing the laminated glass according to claim 14, wherein step (b-1) is conducted prior to step (b-2), or step (b-1) and step (b-2) are conducted simultaneously.
